(19) United States
(12) Patent Application Publication
(10) Pub. No.: US 2021/0018387 A1
(43) Pub. Date: Jan. 21, 2021

(54) PRELOAD FORCE TOOL

(71) Applicant: Edwards Limited, Burgess Hill, West Sussex (GB)

(72) Inventors: Christopher Miles, Burgess Hill, Sussex (GB); Paul Milner, Burgess Hill, Sussex (GB); Richard Salloum, Burgess Hill, Sussex (GB)

(21) Appl. No.: 16/603,073

(22) PCT Filed: Apr. 4, 2018
(86) PCT No.: PCT/GB2018/050910

§ 371 Date: Oct. 4, 2019

(30) Foreign Application Priority Data
Apr. 5, 2017 (GB) 1705465.1

(51) Int. Cl. G01L 5/00; F16C 41/00; F04D 19/04; F04D 29/056; F04D 29/64

(52) U.S. Cl. CPC G01L 5/0009; G01L 5/0038; F16C 41/00; F04D 19/042; F16C 2240/14; F04D 29/64; F16C 2360/45; F16C 2233/00; F04D 29/056

(57) ABSTRACT

The invention relates to a bearing preload force gauge for indicating the bearing preload force on a turbomolecular pump rotor bearing. The gauge comprises a housing, an indicator for indicating the bearing preload force, and actuator coupled to an impeller engagement surface by a member configured to provide a resilient bias between the actuator and the impeller engagement surface. The invention also relates to a bearing preload tool and methods for measuring the bearing preload force on a turbomolecular pump.

### CROSS-REFERENCE OF RELATED APPLICATION

This application is a Section 371 National Stage Application of International Application No. PCT/GB2018/050910, filed Apr. 4, 2018, and published as WO 2018/185483 A1 on Oct. 11, 2018, the content of which is hereby incorporated by reference in its entirety and which claims priority of British Application No. 1705465.1, filed Apr. 5, 2017.

### FIELD

The present invention relates to a force gauge and, in particular, a force gauge for measuring the bearing preload force in a turbomolecular pump. The invention further provides a bearing preload tool comprising a bearing preload force gauge and a bearing preload force adjuster, and methods for measuring a hearing preload force.

### BACKGROUND

Vacuum pumps typically comprise an impeller in the form of a rotor mounted on a shaft for rotation relative to a surrounding stator. The rotor shaft is supported by a bearing arrangement comprising two bearings located at or intermediate respective ends of the shaft. Typically, the upper, inlet-side, bearing may be in the form of a passive magnetic bearing, and the lower, outlet-side, bearing is in the form of a rolling bearing.

In order to improve rolling bearing performance, a bearing preload force may be applied for normal operating conditions, i.e. the rotor shaft assembly will be biased axially in one direction. Typically, the bearing preload force is generated by the upper passive magnetic bearing. Usually, the rotor shaft is biased towards the pump inlet.

Typically, gross stops are featured to limit the axial movement between positive and negative preloads. The gross stops may act upon the rolling bearing outer race or a damping assembly which maybe coupled to the bearing outer race.

The rolling bearing inner race is usually coupled to the turbo rotor shaft. When a large enough force is applied to the rotor, which is opposing the force of the magnetic bearing, the rotor shaft assembly will be forced to change position axially in the opposite direction, this is known as negative preload. The transition from a positive to a negative preload is usually accompanied by an audible noise, e.g. a click or knock.

During servicing, hearing preload measurement and adjustment may be required following a rolling bearing change. This is preferable to ensure that the hearing operates within acceptable preload limits.

A number of methods have been employed to measure the preload force, these include employing force transducers, load cells or weights with carriers. However, force transducers or load cells with their instrumentation have proven prohibitively expensive for in-field use. Whereas, at the lower end of the price scale, the use of weights has proven to be too complicated and too bulky for practical use. Moreover, it relies on the experience and feel of the operator adding further expense in operator training. For these reasons, a cheap, simple and accurate method for measuring the bearing preload force is required.

The present invention addresses these and other problems with the prior art.

The discussion above is merely provided for general background information and is not intended to be used as an aid in determining the scope of the claimed subject matter. The claimed subject matter is not limited to implementations that solve any or all disadvantages noted in the background.

### SUMMARY

Accordingly, in a first aspect, the present invention provides a bearing preload force gauge for indicating the bearing preload force on a turbomolecular pump rotor hearing.

The gauge may comprise a housing, an indicator for indicating the bearing preload force, and an actuator coupled to an impeller engagement surface by a member configured to provide a resilient bias between the actuator and the impeller engagement surface. Typically, the impeller engagement surface may be located at a distal end of an impeller location member, for instance an impeller engagement peg. Typically, the impeller location member will be configured such that in use the impeller engagement surface engages the impeller shaft, or a surface coupled to and directly movable with the impeller shaft, and is movable therewith. Accordingly, a force transferred to the engagement surface may be transferred to the impeller, and/or movement of the engagement surface may move the impeller.

Typically, impeller location member may extend forward of the housing, at rest and/or during use, so as to extend through the turbomolecular pump housing to the impeller.

The impeller location member may further comprise a surface for engaging the resilient bias member, for instance an upper surface of a protrusion, for instance a radially extending circumferential flange on the shaft of the location member.

The actuator, the resilient member, and the impeller location member comprising the impeller engagement surface may be in a sliding arrangement relative to the housing. That is to say, one or more parts are in sliding contact with the housing. Typically, the actuator, the resilient member, and the impeller location member comprising the impeller engagement surface will be arranged to move in a reciprocating motion along a longitudinal axis of the gauge and/or relative to the housing. In use, the longitudinal axis of the gauge may be substantially aligned with the axis of the rotor shaft of the turbomolecular pump.

The housing of the gauge may be configured to couple with the housing of the turbomolecular pump in order to hold the gauge substantially stationary relative thereto during use.

The housing of the gauge may also include means for adjusting the bearing preload force. Typically, the means for adjusting the bearing preload force will be configured to adjust the position of the inner race of a passive magnetic bearing relative to its outer race. Preferably the bearing preload force can be measured and adjusted without removing the gauge from the turbomolecular pump.

The gauge may be arranged such that, in use, the bearing preload force is indicated by coupling the impeller engagement surface with the pump impeller and moving the actuator relative to, typically towards, the engagement surface against the resilient bias. The gauge may be configured such that, as the actuator is moved towards the engagement surface, the restoring (reaction) force provided by the resilient member increases. Typically, the restoring (reaction) force of the resilient member increases until the bearing preload force is overcome (i.e. the bearing preload force changes from positive to negative). Typically, the bearing preload force is indicated when the actuator has moved sufficiently to overcome the bearing preload force.

Advantageously, bearing preload gauges of the invention can be used in any orientation. Accordingly, the gauges are particularly useful in the measurement of multistage turbomolecular pumps, where the rotor shaft and preload force may be in a non-vertical, e.g. horizontal, direction.

Gauges according to the invention are particularly useful in the measurement of the bearing preload force in a turbomolecular pump with an upper, inlet-side, passive magnetic bearing and a lower, outlet-side, rolling bearing, and/or wherein the bearing preload force is positive, i.e. in the direction of the pump inlet. They provide an inexpensive, accurate, and easy to use solution to measuring the bearing preload force in a turbomolecular pump.

The resilient member is configured to provide a resilient bias between the actuator and the impeller engagement surface. That is to say, it resiliently resists movement of the actuator relative to the impeller engagement surface. Typically, the resilient member resiliently resists movement of the actuator towards the impeller engagement surface, i.e. they are biased apart. Typically, the resilient member is a spring, preferably a compression spring, preferably a helical compression spring. Preferably, the spring is substantially linear. The spring rate of the spring may be chosen so that within the spring's compression range, the preferred preload force range is achieved.

Preferably, the gauge is configured so that when the bearing preload force is overcome the bearing preload force indicator provides an indication as to whether the hearing preload force is within, or outside, a predetermined preferred range. Preferably, when the bearing preload force is overcome the bearing preload force indicator provides an indication that the bearing preload force is within a predetermined range if the bearing preload force is within said predetermined preferred range.

Additionally, or alternatively, when the hearing preload force is overcome the bearing preload force indicator may provide an indication that the bearing preload force is outside a predetermined preferred range if the bearing preload force is outside the predetermined preferred range, preferably a different indication to that provided when in said predetermined preferred range.

Preferably, when the bearing preload force is overcome, if the hearing preload force is outside the predetermined preferred range, the indicator indicates whether the bearing preload force is above or below the predetermined preferred range.

Typically, the indications provided by the indicator are visual. Indicium may be selected from the group consisting of structures formed in or on the surface of the housing or actuator, printed indicia, or combinations thereof. The indications may include primary and secondary indicia.

Advantageously, the indicators of the invention may not include a scale or numerical output which must be read and interpreted. Preferably, the user can tell directly from the indicator whether the bearing preload force is within the predetermined preferred range or not, i.e. without having to consult a secondary source to decide whether the bearing preload force is acceptable for that particular turbomolecular pump. A gauge will usually be configured for a specific turbomolecular pump model with a specific pump geometry and predetermined preferred hearing preload force and range.

Typically, the indicator comprises indicium coupled to the housing or actuator and a corresponding indicium identifier, wherein in use the indicium and identifier are movable relative to one another to indicate the bearing preload force. The indicium identifier may be coupled to the other of the housing or actuator. Typically, one of the indicium and identifier will remain stationary relative to the gauge housing and/or turbomolecular pump housing during use. Typically, the indicium will be formed on one of the housing or actuator and the indicium identifier will be formed on the other of the housing or actuator.

An indicium may indicate the lower limit of the preferred preload force range and an indicium may indicate the upper limit of the preferred preload force range. The indicia may be a single indicium or separate, likewise they may be the same or different.

Additionally, or alternatively, the indicator may comprise an indicium identifying when the bearing preload force is in the predetermined preferred preload force range. In an embodiment, the indicator includes a first indicium indicating the lower limit of the preferred preload force range, a second indicium identifying the preferred preload force range, and a third indicium indicating the upper limit of the preferred preload force range.

In embodiments, the indicia may be in the form of a series of steps formed in an upper portion of the gauge housing. Typically, a first upper step indicates the lower limit of the preferred preload force range and a second, typically adjacent, lower step indicates the upper limit of the preferred preload force range.

Additionally, the first step and the second step may each comprise a secondary indicium indicating the preferred preload force range. For instance, a first secondary indicium may be present on the first step indicating that above that step is outside of the predetermined preferred range. Additionally, or alternatively, the second step may include a second secondary indicium, different to the first indicium, indicating that above the second step, but below the first step, is within the predetermined preferred range. Optionally, a third still lower step may include a secondary indicium indicating that below the second step is outside the predetermined preferred range.

The secondary indicium for the second step may be written or a symbol and may generally indicate a positive outcome, e.g. “Go”, “Pass”, the colour green, or a tick. Additionally, or alternatively, the secondary indicium for the first and/or optional third step may be written or a symbol, and may generally indicate a negative outcome, e.g. “No Go”, “Fail”, the colour red, or a cross.

Additionally, or alternatively, the indicium identifier may be in the form of a printed marking, protrusion or indentation on an outer surface of the actuator which in use. moves with the actuator relative to the steps. Accordingly, when the force applied to the actuator overcomes the bearing preload force the position of the identifier relative to the indicium indicates whether the bearing preload force is within the predetermined preferred range.

Alternatively, the indicium identifier may include part of the housing of the gauge, or a marking, protrusion or indentation on the housing of the gauge, and the actuator may include indicia or indicium identifying the upper and lower limits of the preferred preload force range, the actuator being movable relative to the housing.

Typically, overcoming the bearing preload force is accompanied by an audible signal, such as a click. In use, the user can use the audible signal to determine when the bearing preload force has been overcome and therefore when to take a measurement from the indicator. Additionally, or alternatively, the user may be able to feel when the bearing preload force has been overcome because further movement of the actuator will require a lesser increase in force.

In embodiments, the gauge may further comprise a preload force adjuster for altering the bearing preload force on the rotor of the turbomolecular pump.

Moreover, the invention further provides a preload force tool for a turbomolecular pump configured such that the bearing preload force is adjustable, the tool comprising a preload force indicator and a preload force adjuster. The bearing preload force gauge may comprise any of the features disclosed in other aspects of the invention.

Typically, the turbomolecular pump will comprise a passive magnetic bearing applying the bearing preload force and the bearing preload force adjuster will be configured to adjust the magnitude of the bearing preload force applied by the magnetic bearing. The hearing preload force adjuster may be able to move the inner race of the magnetic bearing relative to the outer race.

Preferably the tool can be used to measure and adjust the hearing preload force without decoupling the tool from the turbomolecular pump.

The housing, actuator, and impeller location member may each be formed using additive manufacturing, e.g. 3D printing. Typically, they will be made from a polymer. The spring will typically comprise spring steel or another suitably alloy.

The housing, actuator and impeller location member of the invention may each be manufactured from a material selected from the group consisting of a polymer, a composite, and a metal or alloy.

Polymers are particularly preferred and may be selected from group consisting of elastomers, thermoplastic materials or thermosets. Thermoplastic materials are preferred. Typically, the polymer is selected from the group consisting of polyolefins, such as polyethylene and polypropylene; polyvinylchloride, and polyethylene terephthalate, and derivatives and copolymers thereof.

The polymers may additionally include one or more from the group consisting antistatics, antioxidants, mould release agents, flameproofing agents, lubricants, colorants, flow enhancers, fillers, including nanofillers, light stabilizers and ultraviolet light absorbers, pigments, anti-weathering agents and plasticisers.

In a further aspect, the invention provides a bearing preload force gauge for indicating the bearing preload force on a turbomolecular pump rotor bearing comprising a housing, an indicator for indicating the bearing preload force, and an actuator coupled to an impeller location member by a member configured to provide a resilient bias between the actuator and the impeller location member wherein one or more of the housing, indicator, actuator and impeller location member is additive manufactured.

In all aspects and embodiments of the invention the predetermined preferred range for the bearing preload force may be between about 5 N and about 50 N, preferably between about 8 N and about 10.5 N. Typically, the span of the range is no more than 1.5 N, preferably 1 N, either side of a preferred bearing preload force for the turbomolecular pump. Typically, the predetermined preferred bearing preload force is between about 8 N and about 10.5 N, an example is about 9.3 N.

The spring (resilient member) will be chosen such that the return (reaction) force may be equal to the force required to overcome the bearing preload force within the compression range of the spring. The gauge may be varied to accommodate different preload forces for different turbomolecular pumps by selecting an alternative spring with an alternative spring rate, or by altering the arrangement of the indicator (e.g. the spacing between the parts of the indicator indicating the upper and lower extremities of the predetermined preferred bearing preload force), or a combination thereof. The resilient member (spring) and configuration of the indicator will be selected such that, in use, if the bearing preload force is within a predetermined preferred range the indicator indicates that this is the case, whereas, if the bearing preload force is outside the predetermined range, again the indicator indicates that is the case.

Preferably, the distance on the indicator between the indicium indicating the lower end of the range for the predetermined preferred bearing preload force and the indicium indicating the upper end of the range for predetermined preferred bearing preload load force will be greater than 1 mm, preferably from about 1 mm to about 20 mm, 2 mm being an example.

In all aspects and embodiments of the invention, the bearing preload force gauge and/or preload force tool is typically substantially free from electronics, preferably free from electronics. Typically, the gauge and/or tool, and, in particular, the indicator is entirely mechanical.

In a further aspect of the invention, there is provided a method of measuring the bearing preload force of a turbomolecular pump.

The method may comprise the steps of providing a turbomolecular pump comprising a rotor hearing having a preload force applied thereto; providing preload force gauge comprising a housing, an indicator for indicating the bearing preload three, and an actuator coupled to an impeller engagement surface by a member configured to provide a resilient bias between the actuator and the impeller engagement surface; coupling the impeller engagement surface to the impeller; moving the actuator relative to the engagement surface against the resilient bias so as to overcome the bearing preload force on the bearing; and reading an indication of the bearing preload force from the indicator when the bearing preload force is overcome.

The gauges according to any other aspect or embodiment of the invention may be used in said method.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE FIGURES

Preferred features of the present invention will now be described, by way of example, with reference to the accompanying drawings, in which:

FIG. 1 shows a section view of a bearing preload force gauge.

FIG. 2 shows a section view of a bearing preload force gauge in situ.

FIG. 3 shows a bearing preload force gauge.

FIG. 4 shows a schematic of a beating preload force gauge illustrating an indicator preferred range.

FIG. 5 shows a hearing preload force gauge at rest.

FIG. 6 shows a bearing preload force gauge in a fail configuration (preload force is too low).

FIG. 7 shows a hearing preload force gauge in a pass configuration.

FIG. 8 shows a hearing preload three gauge in a fail configuration (preload force is too high).

FIG. 9 shows an alternative indicator in a series of configurations.

### DETAILED DESCRIPTION

The present invention provides a bearing preload force gauge for indicating the bearing preload force on a turbomolecular pump rotor bearing.

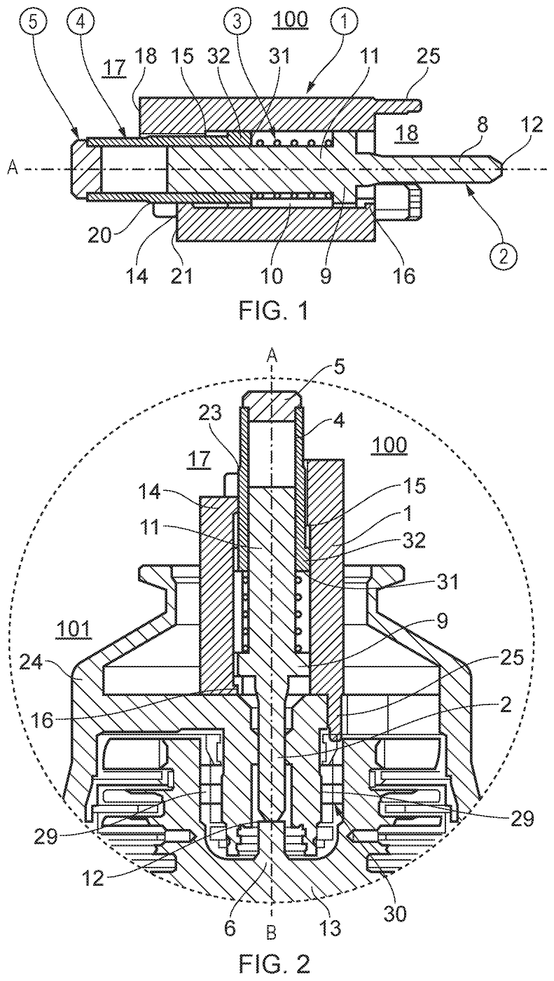

As illustrated in FIG. 1, in an example, the gauge (100) comprises a housing (1), an impeller location member (2), an actuator (4) and a resilient member (3) (in the illustrated example a helical compression spring) between the actuator (4) and the impeller location member (2).

Referring also to FIG. 2, the impeller location member (2) is configured to transmit a force applied thereto by the actuator (4) to the impeller (6) of the turbomolecular pump (7). The impeller location member (2) comprises a forward portion (8) configured to extend forward of the housing (1) to couple with the pump impeller (7) and a radially extending circumferential flange (9) that slidably engages with an inner wall (10) of the gauge housing (1). The circumferential flange (9) may be located generally centrally along the length of the impeller location member (2), dividing the forward portion (8) of the location member from a rear portion (11). The illustrated impeller location member (2) further comprises a rearward portion (11) slidably receivable within the spring (3) and actuator (4).

At its tip the impeller location member (2) comprises a impeller engagement surface (12) which, in use, couples with the impeller (6), preferably the surface (12) directly engages the impeller (6), preferably the surface directly engages the rotor shaft (13).

The illustrated housing (1) is generally cylindrical with a central channel configured to receive the actuator (4), resilient member (3) and the impeller location member (2). The wall of the central channel (formed by the inner wall of the housing (10)) may comprise ribs or channels configured to engage with corresponding protrusions or indentations on the actuator (4) and/or impeller location member (2), to aid sliding. The channel further includes shoulders (14, 15, 16) at proximal (17) and distal (18) ends thereof to retain the actuator (4) and impeller location member (2) within the housing (1).

The housing (1) further includes a series of steps (19, 20, 21) on its upper surface (22). These, along with a circumferential indentation (23) on the actuator (4), form the indicator for indicating whether the bearing preload force is within a predetermined preferred range.

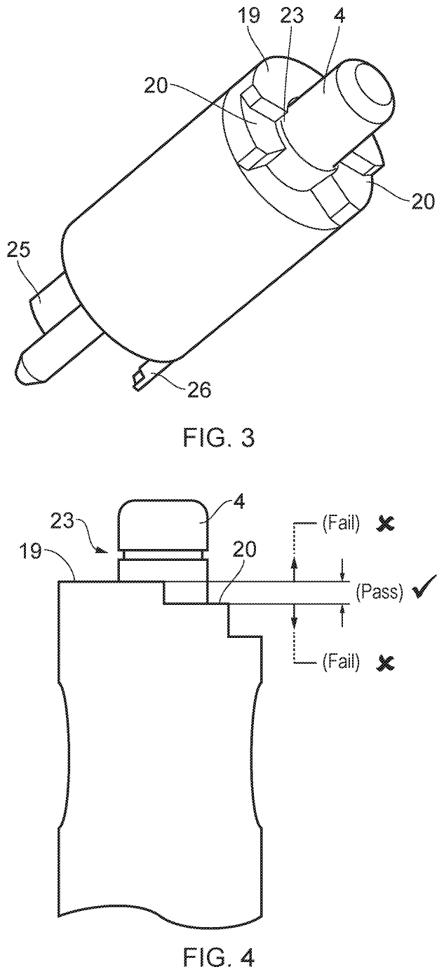

As better illustrated in in FIGS. 3 and 4, in the example, the upper step (19) indicates lower limit of the predetermined preferred bearing preload force range and the second step indicates the upper limit of the predetermined preferred bearing preload three range (20). In this example, the circumferential indentation (23) on the actuator (4) is the indicium identifier, whereas the steps form the primary indicia. The steps (19, 20) further include secondary indicia “Go” and “No Go” formed in their surfaces. If, when the bearing preload force is overcome, the indicium identifier (23) is located between the upper step (19) and second step (20), as illustrated in FIG. 4, this is a pass (i.e. the bearing preload force is in the predetermined preferred range). Alternatively, if, when the bearing preload force is overcome, the indicium identifier is located above the upper first step (19), as illustrated in FIG. 4, this is a fail (the bearing preload force is too low).

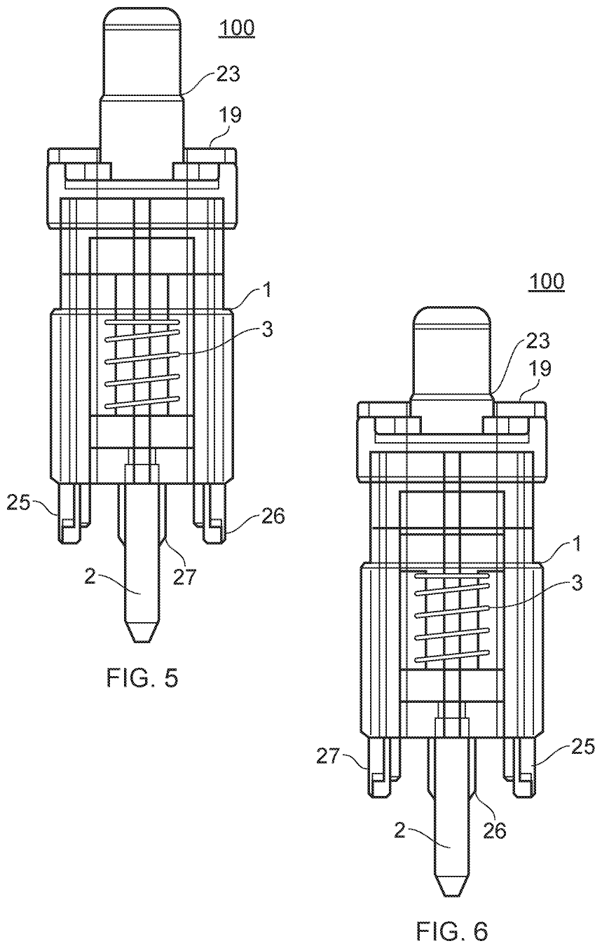

As illustrated in FIG. 2, the lower end of the gauge housing (1) is configured to couple with the housing of the turbomolecular pump (24) so that the gauge housing (1) remains substantially stationary relative to the pump housing (24) whilst a bearing preload force measurement is taken. The lower (distal) end of the exemplified housing (1) further includes three adjustor drive legs (25, 26, 27) (better illustrated in FIGS. 5 to 8). The adjustor drive legs (25, 26, 27), as well as contributing to the stability of the gauge (100) during use, are configured to allow the gauge (100) to adjust the bearing preload force, typically by facilitating movement of the inner race (28) of the passive magnetic bearing (30) relative to its outer race (29). By rotating the device (100) about its longitudinal axis (A) in one direction the bearing preload force can be increased, whereas by rotating the device (100) about its longitudinal axis (A) in an opposite direction the bearing preload force can be decreased. Advantageously, the bearing preload force can be measured and adjusted by the same device (100) and without decoupling said device (100) from the turbomolecular pump (101). Typically, the hearing preload force is adjusted when the gauge (100) is in an at rest configuration.

The actuator (4) comprises rearward facing user interface (5) which in use may be pressed by an operator thumb or finger. The actuator (4) further comprises a resilient member (e.g. spring) engagement surface (31), in the example the downward (forward) facing surface (31) of a radially extending circumferential flange (32) at a distal end of the actuator (4). The actuator (4) is configured to slide in a reciprocating motion within the housing channel (10). The actuator (4) comprises an inner channel (33) configured to receive the rearward portion (11) of the impeller location member (2) in a reciprocating sliding arrangement.

When pushed in a forward (downward) direction, the actuator (4) pushes the spring against the impeller location member (2), thereby compressing the spring (3). The impeller location member (2) transmits the force to the impeller (6) of the turbomolecular pump (101). By increasing the force applied to the actuator (4), the spring (3) is compressed further and the spring's restoring (reaction) force increases: likewise, the force transmitted to the impeller (6) (and rotor bearing) increases. The force applied to the actuator (4) is increased until the force transmitted to the impeller (6) is sufficient to overcome the bearing preload force. At that point a click will be heard and the indicator is read to establish whether the bearing preload force is within its predetermined preferred range.

Releasing the actuator (4) allows the gauge (100) and turbomolecular pump (101) to return to their respective at rest positions.

If the bearing preload force was not within the predetermined preferred range for that turbomolecular pump (101), the bearing preload force can be adjusted and the bearing preload force remeasured. The process may be repeated until the bearing preload force is within the predetermined preferred range.

The exemplified device is for use on a nEXT85™ available from Edwards Vacuum™ and is configured to have a predetermined preferred bearing force range of from about 8.3 N to about 10.3 N. The illustrated spring is a LC036G05S available from Lee Spring Ltd. with a spring rate of 1.05 N/mm The distance between the uppermost step and the next step is 2 mm. The skilled person will appreciate that the specific spring and indicator arrangement will be chosen depending on the preferred hearing preload force range for a specific turbomolecular pump.

The illustrated device may be handheld and/or manually actuated. By manually actuated it is understood that the force required to overcome the bearing preload force is applied to the actuator by the operator's hand.

The housing, actuator and impeller location member are additive manufactured from Objet Veroblue RGD840.

FIGS. 5 to 8 illustrate the device in various configurations. FIG. 5 shows the device (100) in its at rest configuration. In this configuration, no force is applied to the actuator (4), the spring (3) is not displaced or compressed, and the actuator (4) and the impeller location member (2) are in their most upward positions. in this configuration, the circumferential groove (23) of the indicator is well above the top step (19) of the gauge housing (1).

FIG. 6 illustrates the device (100) in a configuration where the bearing preload force is too low. The spring (3) is compressed and the actuator (4) has moved downward (forward) relative to the housing (1); however, the circumferential groove (23) is above the top step (19) of the gauge housing (1) indicating that bearing preload force is too low.

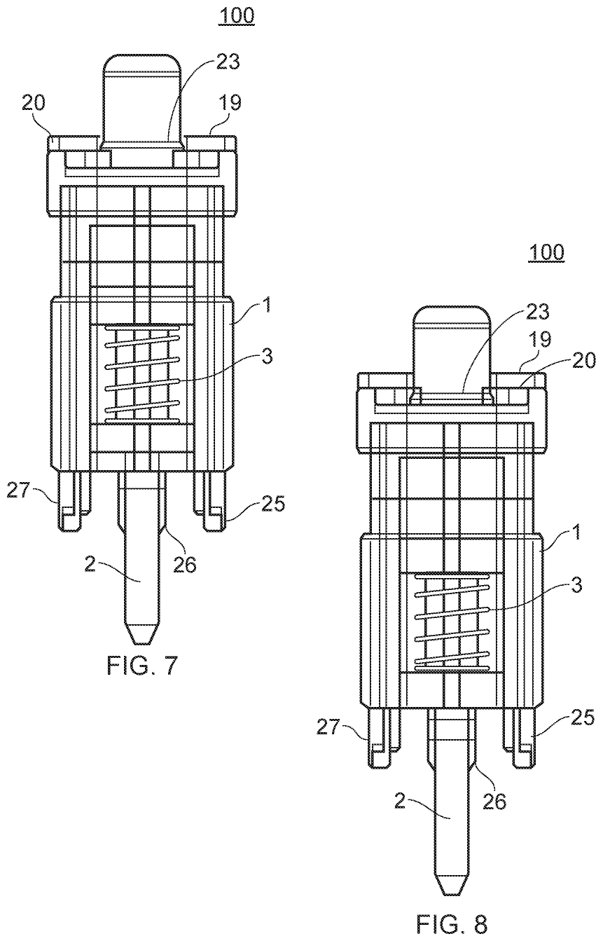

FIG. 7 illustrates the device (100) in a configuration where the bearing preload force is within the predetermined preferred range. The spring (3) is further compressed and the actuator (4) and impeller location member (2) have moved further downward (forward) relative to the housing (1). In this configuration, the circumferential groove (23) is below the top step (19) of the gauge housing, but above the second step (20), illustrating that bearing preload force is within the predetermined preferred range.

FIG. 8 illustrates the device in a configuration where the bearing preload force is too high. The spring (3) is compressed further still and the actuator (4) and impeller location member (2) have moved even further downward (forward) relative to the housing (1). In this configuration, the circumferential groove (23) is below the second step (20) of the gauge housing (1), indicating that bearing preload force is too high.

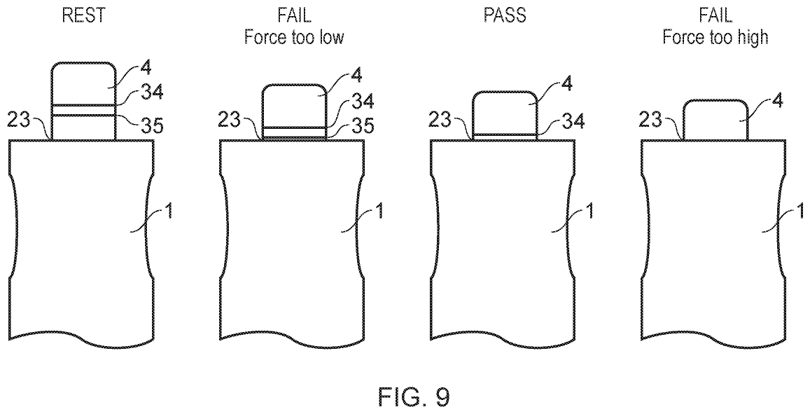

FIG. 9 illustrates an alternative example of an indicator suitable. for use in the present invention in a series of configurations. In this example, the indicator comprises two indicia (34, 35) in form of circumferential grooves formed in the surface of the actuator (4). in use, as the actuator (4) is pushed into the housing (1), the upper groove (34) indicates the lower limit of the predetermined preferred range for the hearing preload force, whereas the lower groove (35) indicates the upper limit of the predetermined preferred range for the bearing preload force. In this example, the indicium identifier (23) is the upper surface of the gauge housing (1) immediately adjacent the actuator (4).

Thus, in contrast to the previous example, the indicium (34, 35) are located on the actuator (4) and movable relative to a stationary indicium identifier (23) located on the housing (1).

Accordingly, as illustrated, if as the bearing preload force is overcome during testing both grooves (34, 35) are above the housing (1) then the bearing preload force is too low, whereas if neither of the grooves is above the housing (1) then the bearing preload force is too high. In contrast, if when the bearing preload force is overcome the upper groove (34) is above the housing (1) but the lower groove is not, then the bearing preload force is within the predetermined preferred range. In this example, no secondary indicia are employed. It will be appreciated that the grooves could be replaced with printed lines or other suitable indicia.

It will be appreciated that various modifications may be made to the embodiments shown without departing from the spirit and scope of the invention as defined by the accompanying claims as interpreted under patent law.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A bearing preload force gauge for indicating the bearing preload force on a turbomolecular pump rotor bearing, the gauge comprising a housing, an indicator for indicating the bearing preload force, and actuator coupled to an impeller engagement surface with a member configured to provide a resilient bias between the actuator and the impeller engagement surface.

2. The gauge according to claim 1, wherein, in use, the bearing preload force is indicated by coupling the impeller engagement surface with a pump impeller and moving the actuator relative to the engagement surface against the action of the resilient bias member to overcome the bearing preload force.

3. The gauge according to claim 1 wherein the actuator, the resilient bias member, and an impeller location member comprising the impeller engagement surface are movable in a reciprocating motion relative to the housing.

4. The gauge according to claim 1 wherein when the bearing preload force is overcome the indicator provides an indication as to whether the bearing preload force is within or outside a predetermined preferred range.

5. The gauge according to claim 4 wherein when the bearing preload force is overcome the indicator provides a first indication if the bearing preload force is within the predetermined preferred range.

6. The gauge according to claim 5 wherein when the bearing preload force is overcome the indicator provides a second indication if the bearing preload force is outside the predetermined preferred range, said second indication being different from the first indication.

7. The gauge according to claim 4 wherein when the bearing preload force is overcome if the bearing preload force is outside the predetermined preferred range the indicator indicates whether the bearing preload force is above or below the predetermined preferred range.

8. The gauge according to claim 1 wherein the indication provided by the indicator is visual.

9. The gauge according to claim 1 wherein the indicator comprises indicium coupled to the housing or actuator and an indicium identifier, wherein in use the indicium and identifier are movable relative to one another to indicate the bearing preload force.

10. The gauge according to claim 9 wherein an indicium indicates the lower limit of a predetermined preferred preload force range and an indicium indicates the upper limit of the predetermined preferred preload force range.

11. The gauge according to claim 9 comprising an indicium indicating when the bearing preload force is in a predetermined preferred range.

12. The gauge according to claim 9 wherein the indicium comprises a stepped upper surface on the housing and wherein a first step indicates a lower limit of a predetermined preferred preload force range and a second step indicates the upper limit of the predetermined preferred preload force range.

13. The gauge according to claim 12 wherein the first step and the second step each comprise a secondary indicium indicating the predetermined preferred preload force range.

14. The gauge according to claim 1 wherein the resilient member comprises a spring, preferably a compressive spring, preferably a helical compressive spring.

15. The gauge according to claim 1 wherein overcoming the bearing preload force is accompanied by an audible signal.

16. The gauge according to claim 1 further comprising a preload force adjuster for altering the bearing preload force on the rotor bearing of the turbomolecular pump.

17. A preload force tool for a turbomolecular pump comprising a rotor bearing under an adjustable preload force, the tool comprising a preload force gauge and a preload force adjuster.

18. The tool according to claim 17 wherein the gauge comprises a housing, an indicator for indicating the preload force, and actuator coupled to an impeller engagement surface with a member configured to provide a resilient bias between the actuator and the impeller engagement surface.

19. A method for measuring the bearing preload force on a turbomolecular pump rotor bearing, the method comprising the steps of:
a) providing a turbomolecular pump comprising a rotor bearing having a preload force applied thereto;
b) providing preload force gauge comprising a housing, an indicator for indicating the bearing preload force, and an actuator coupled to an impeller engagement surface with a member for providing a resilient bias;
c) coupling the impeller engagement surface with the impeller;
d) moving the actuator relative to the impeller engagement surface against the resilient bias so as to overcome the bearing preload force on the rotor bearing; and
e) reading an indication of the bearing preload force from the indicator when the bearing preload force is overcome
f) further comprising adjusting the bearing preload force using the gauge and optionally remeasuring the bearing preload force without removing the gauge from the turbomolecular pump.

20-22. (canceled)
